(19) United States
(12) Patent Application Publication
(10) Pub. No.: US 2022/0365219 A1
(43) Pub. Date: Nov. 17, 2022

(54) Pixel Mapping Solid-State LIDAR Transmitter System and Method

(71) Applicant: OPSYS Tech Ltd., Holon (IL)

(72) Inventors: Niv Maayan, Gealiya (IL); Mark J. Donovan, Mountain View, CA (US)

(73) Assignee: OPSYS Tech Ltd., Holon (IL)

(21) Appl. No.: 17/739,859

(22) Filed: May 9, 2022

Related U.S. Application Data
(60) Provisional application No. 63/187,375, filed on May 11, 2021.

(51) Int. Cl. G01S 17/894; G01S 7/481; G01S 7/4863; G01S 7/4865

(52) U.S. Cl. CPC G01S 17/894; G01S 7/4815; G01S 7/4816; G01S 7/4863; G01S 7/4865

(57) ABSTRACT

A LiDAR system includes a transmitter having a first and second laser emitter generating first and second optical beams and projecting the optical beams along a transmitter optical axis. A receiver includes an array of pixels positioned with respect to the receive optical axis such that light from the first optical beam reflected from an object forms a first image area and light from the second optical beam reflected by the object forms a second image area on the array of pixels such that an overlap region between the first image area and the second image area is formed based on a measurement range and on a relative position of the transmitter optical axis and the receive optical axis. A processor determines what pixels are in the overlap region from electrical signals generated by at least one pixel in the overlap region and generates a return pulse in response.

### CROSS REFERENCE TO RELATED APPLICATIONS

The present application is a non-provisional application of U.S. Provisional Patent Application No. 63/187,375, entitled “Pixel Mapping Solid-State LIDAR Transmitter System and Method” filed on May 11, 2021. The entire contents of U.S. Provisional Patent Application No. 63/187,375 are herein incorporated by reference.

The section headings used herein are for organizational purposes only and should not be construed as limiting the subject matter described in the present application in any way.

### INTRODUCTION

Autonomous, self-driving, and semi-autonomous automobiles use a combination of different sensors and technologies such as radar, image-recognition cameras, and sonar for detection and location of surrounding objects. These sensors enable a host of improvements in driver safety including collision warning, automatic-emergency braking, lane-departure warning, lane-keeping assistance, adaptive cruise control, and piloted driving. Among these sensor technologies, light detection and ranging (LIDAR) systems take a critical role, enabling real-time, high-resolution 3D mapping of the surrounding environment.

Most commercially available LIDAR systems used for autonomous vehicles today utilize a small number of lasers, combined with some method of mechanically scanning the environment. It is highly desired that future autonomous automobiles utilize solid-state semiconductor-based LIDAR systems with high reliability and wide environmental operating ranges.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale; emphasis instead generally being placed upon illustrating principles of the teaching. The drawings are not intended to limit the scope of the Applicant's teaching in any way.

FIG. 1 illustrates a known imaging receiver system.

FIG. 2A illustrates an embodiment of a pixel-mapping Light Detection and Ranging (LiDAR) system that uses a separate transmitter and receiver of the present teaching.

FIG. 2B illustrates a block diagram of an embodiment of a pixel-mapping LiDAR system that includes a separate transmitter and receiver system connected to a host processor of the present teaching.

FIG. 3 illustrates an embodiment of a one-dimensional detector array used in a pixel-mapping LiDAR system of the present teaching.

FIG. 4 illustrates an embodiment of a two-dimensional detector array used in a pixel-mapping LiDAR system of the present teaching.

FIG. 5 illustrates a known two-dimensional detector array used in a known LiDAR system.

FIG. 6 illustrates the impact of parallax of a single laser in an embodiment of a two-dimensional detector array used in a pixel-mapping LiDAR system of the present teaching.

FIG. 7 illustrates the impact of parallax for two adjacent lasers in the embodiment of the two-dimensional detector array of FIG. 6.

FIG. 8 illustrates a flow diagram of steps in an embodiment of a method of pixel mapping for LiDAR of the present teaching.

### DESCRIPTION OF VARIOUS EMBODIMENTS

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the method of the present teaching can be performed in any order and/or simultaneously as long as the teaching remains operable. Furthermore, it should be understood that the apparatus and method of the present teaching can include any number or all of the described embodiments as long as the teaching remains operable.

The present teaching relates generally to Light Detection and Ranging (LIDAR), which is a remote sensing method that uses laser light to measure distances (ranges) to objects. LIDAR systems generally measure distances to various objects or targets that reflect and/or scatter light. Autonomous vehicles make use of LIDAR systems to generate a highly accurate 3D map of the surrounding environment with fine resolution. The systems and methods described herein are directed towards providing a solid-state, pulsed time-of-flight (TOF) LIDAR system with high levels of reliability, while also maintaining long measurement range as well as low cost.

In particular, the present teaching relates to LIDAR systems that send out a short time duration laser pulse, and use direct detection of the return pulse in the form of a received return signal trace to measure TOF to the object. Also, the present teaching relates to systems that have transmitter and receiver optics, which are physically separate from each other in some fashion.

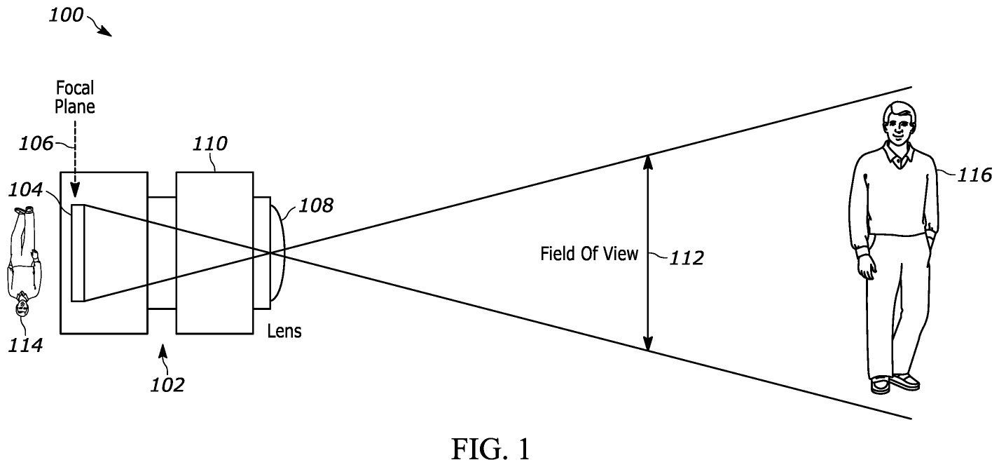

FIG. 1 illustrates a known imaging receiver system 100. The system 100 includes a receiver 102 that includes a detector array 104 positioned at a focal plane 106 of a lens system 108. The detector array 104 could be a two-dimensional array. The detector array 104 can be referred to as an image sensor. The lens system 108 can include one or more lenses and/or other optical elements. The lens system 108 and array 104 are secured in a housing 110. The receiver 102 has a field-of-view 112, and produces a real image 114 of a target 116 in that field-of-view 112. The real image 114 is created at the focal plane 106 by the lens system 108. The real image 114 produced by the array 104 is shown projected onto the focal plane 106 with paraxial ray projection, and is inverted compared to the actual target.

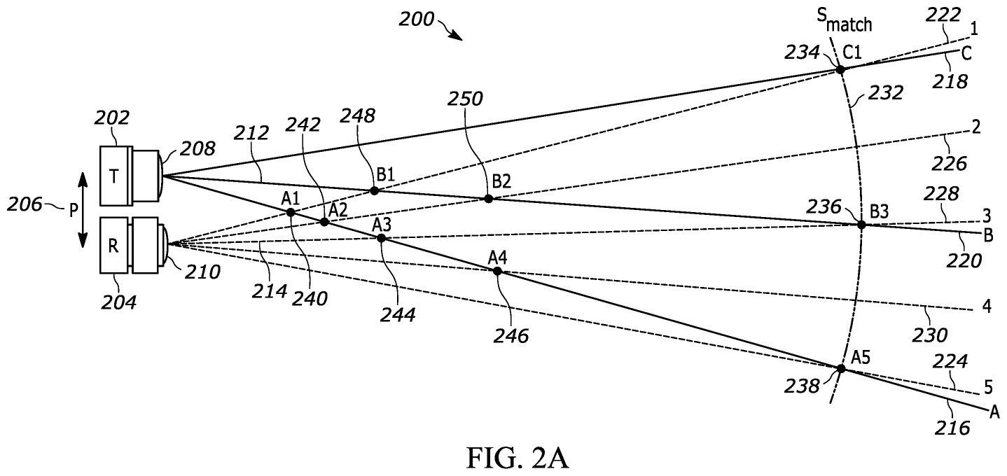

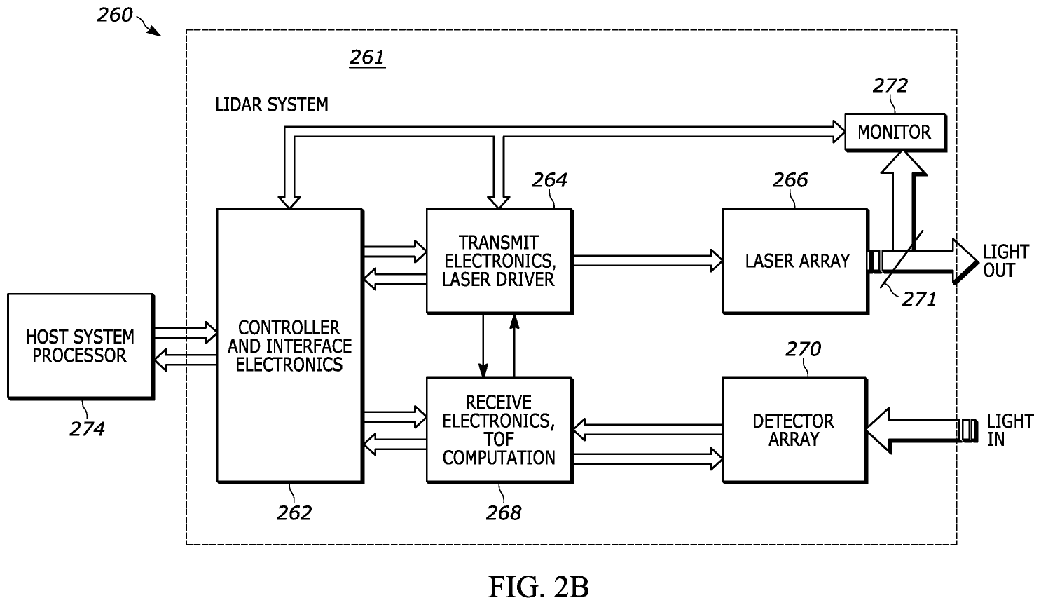

FIG. 2A illustrates an embodiment of a pixel-mapping Light Detection and Ranging (LiDAR) system 200 that uses a separate transmitter and receiver of the present teaching. A separate transmitter 202 and receiver 204 are used. The transmitter 202 and receiver 204 have centers positioned a distance 206, P, from each other. The transmitter 202 has an optical lens system 208 that projects light from the transmitter 202. The receiver 204 has an optical lens system 210 that collects light. The transmitter has an optical axis 212 and the receiver 204 has an optical axis 214. The separate transmitter optical axis 212 and receiver optical axis 214 are not co-axial but instead offset radially. The radial offset between the optical axes 212, 214 of the transmitter and receiver lens systems 208, 210 is herein referred to as parallax.

The transmitter 202 projects light within a field-of-view (FOV) corresponding to the angle between ray A 216 and ray C 218 in the diagram. The transmitter contains a laser array, where a subset of the laser array can be activated for a measurement. The transmitter does not emit light uniformly across the full FOV during a single measurement, but instead emits light within only a portion of the field of view. More specifically, the rays A 216, B 220, and C 218 form a center axis for individual laser beams which have some divergence, or cone angle, around that axis. That is, ray B 220 is the same as the optical axis 212 of the transmitter 202. In some embodiments, each ray 216, 218, 220 can be associated nominally with light from a single laser emitter in a laser array (not shown) in the transmitter 202. It should be understood that a laser emitter can refer to a laser source with either a single physical emission aperture, or multiple physical emission apertures that are operated as a group. In some embodiments, each ray 216, 218, 220 can be associated nominally with light from a group of contiguous individual laser emitter elements in a laser array (not shown) in the transmitter 202. In a similar ray analysis, the receiver receives light within a FOV corresponding to the angle between ray 1 222 and ray 5 224 in the diagram. The light is collected with a distribution across the FOV that includes (for illustration purposes) light along ray 2 226, ray 3 228 and ray 4 230. More specifically, ray 3 228 forms the center axis 214 for collected light which has some divergence, or cone angle, around that axis. In some embodiments, each ray 226, 228, 230 can be associated nominally with received light from a single detector element in a detector array (not shown) in the receiver 204. In some embodiments, each ray 226, 228, 230 can be associated nominally with received light from a group of contiguous individual detector elements in a detector array (not shown) in the transmitter 202. The single detector elements or contiguous groups of detector elements can be referred to as a pixel.

The design of the transmitter 202, including the laser source (not shown) and the lens system 208, is configured to produce illumination with a FOV having the central axis 212. The design of the receiver 204, including the detector array (not shown) and the lens system 208 positions, is configured to collect illumination with a FOV having the central axis 214. The central axis 212 of the FOV of the transmitter 202 is adjusted to intersect the central axis 214 of the FOV of the receiver 204 at a surface 232 indicated by S_{MATCH}. This surface 232 is smooth. In some embodiments, the surface is nominally spherical. In other embodiments, the surface is not spherical as it depends on the design of the optical systems in the transmitter 202 and receiver 204, including their relative distortion. Several intersection points 234, 236, 238 along the surface 232 between the illumination from the transmitter 202 and collected light from the receiver 204 are indicated. The first letter corresponds to a transmitter 202 ray, and the second letter corresponds to a receiver 204 array. That is, point 234, C1, is the intersection of transmitter 202 ray C 218 and receiver 204 ray 1 222. Point 236, B3, is the intersection of transmitter 202 ray B 220 and receiver 204 ray 3 228. Point 238, A5, the intersection of transmitter 202 ray A 216 and receiver 204 ray 5 224. Other intersection points 240, 242, 244, 246, 248, 250 are also indicated, having the same naming convention as points 234, 236, 238 along the surface 232. As is clear to those skilled in the art, a complete three-dimensional set of these intersection points can be applied to any particular pair of transmitters 202 and receivers 204, based on their relative center position 206, optic axes 212, 214 directions and FOVs.

FIG. 2B illustrates a block diagram of an embodiment of a pixel-mapping LiDAR system 260 that includes a transmitter and receiver system 261 connected to a host processor 274 of the present teaching. The LiDAR system 261 has six main components: (1) controller and interface electronics 262; (2) transmit electronics 264 including the laser driver; (3) the laser array 266; (4) receive and time-of-flight and intensity computation electronics 268; (5) detector array 270; and (6) in some embodiments an optical monitor 272. The LiDAR system controller and interface electronics 262 controls the overall function of the LiDAR system 261 and provides the digital communication to the host system processor 274. The transmit electronics 264 controls the operation of the laser array 266 and, in some embodiments, sets the pattern and/or power of laser firing of individual elements in the array 266.

The receive and time-of-flight computation electronics 268 receives the electrical detection signals from the detector array 270 and then processes these electrical detection signals to compute the range distance through time-of-flight calculations. The receive and time-of-flight computation electronics 268 can also control the pixels of the detector array 270, in order to select subsets of pixels that are used for a particular measurement. The intensity of the return signal is also computed in electronics 268. In some embodiments, the receive and time-of-flight computation electronics 268 determines if return signals from two different emitters in the laser array 206 are present in a signal from a single pixel (or group of pixels associated with a measurement). In some embodiments, the transmit controller 264 controls pulse parameters, such as the pulse amplitude, the pulse width, and/or the pulse delay.

The block diagram of the LiDAR system 260 of FIG. 2B illustrates connections between components, and is not intended to restrict the physical structure in any way. The various elements of the system 260 can be physically located in various positions depending on the embodiment. In addition, the elements can be distributed in various physical configurations depending on the embodiment. Referring to both FIG. 2A and FIG. 2B, in some embodiments a module for a transmitter 202 can house both a laser array 266 component, transmit electronics, and laser driver 264 processing elements. In some embodiments a module for a receiver 204 can house both a detector array 270 component receive electronics, and TOF computation 268 processing elements.

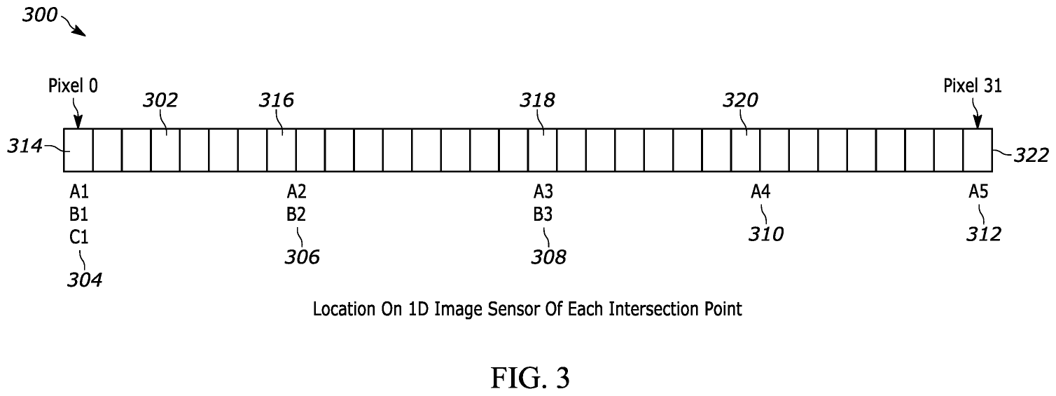

FIG. 3 illustrates an embodiment of a one-dimensional detector array 300 used in a pixel-mapping LiDAR system of the present teaching. This figure represents a simple 1D detector array 300 for simplicity, although the present teaching is not so limited. The detector array 300 has thirty-two pixels 302 in one dimension. The array 300 in the illustration of FIG. 3 is simplified for illustration purposes. There are many configurations of the one-dimensional detector array 300 within the scope of the present teaching. In some configurations, a pixel 302 represents one element of the image sensor, for example, in the receiver 204 in the system 200 shown in FIG. 2A. In some configurations, the detector array 300 is two dimensional. In some configurations, the detector array 300 includes many more than thirty-two pixels 302. In some configurations, a pixel 302 is a single element of an array of detectors (e.g. single photon avalanche detector (SPAD), silicon photo-multiplier (SiPM)). In some configurations a pixel 302 is a contiguous group of individual detectors (e.g. single photon avalanche detector (SPAD), silicon photo-multiplier (SiPM)).

Referring to both to FIG. 2A and FIG. 3, the location of each intersection point 234, 236, 238, 240, 242, 244, 246, 248, 250 is shown in relation to a position 304, 306, 308, 310, 312 at the image plane at which a reflected pulse corresponding to a target placed at each intersection point 234, 236, 238, 240, 242, 244, 246, 248, 250 would be received. It can be seen that A1 240, B1 248, and C1 234 are all imaged to the same pixel 314. It can also be seen that the A ray 216 will result in a reflected signal being received at every pixel in the array, depending on the target distance, and the location within the receiver FOV. For example, points A2 242, pixel 316, A3 244, pixel 318, A4 246, pixel 310 and A5 234, pixel 322 all fall onto the array 300. On the other hand, only one of the marked intersection points for the C ray 218 fall on the array 300, that is point C1 234, pixel 314. Several of the marked intersection points for the B ray 220 fall on the array 300, e.g. points B1 248, pixel 314, B2 248, pixel 316, and B3 250, pixel 318.

As such, the parallax between a transmitter and a receiver, creates a geometry where the particular pixel that receives a reflected pulse is a function both of the position of the laser being fired (i.e. which laser ray), and the position within the FOV (i.e. which receiver ray). Therefore, there is no one-to-one correspondence between laser ray and receiver ray (i.e. laser element and receiver element). Rather, the correspondence depends on the distance of the reflecting target.

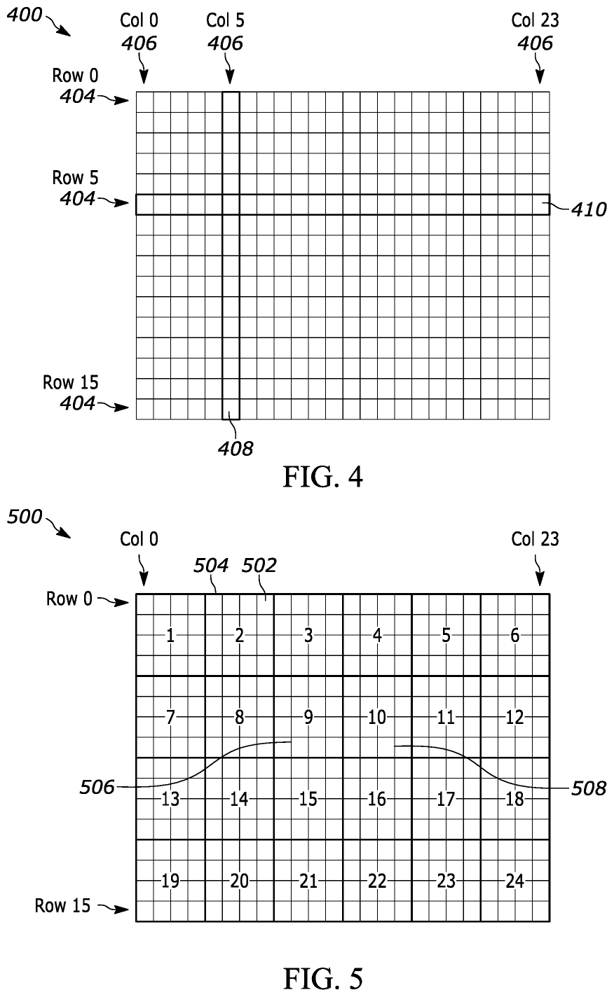

FIG. 4 illustrates an embodiment of a two-dimensional detector array 400 used in a pixel-mapping LiDAR system of the present teaching. In some embodiments, the detector array 400 is any of a variety of known two-dimensional imaging pixel arrays. The array 400 includes pixels 402 arranged in rows 406 and columns 408. For example, many cameras employ known 2D detector arrays that use a rolling shutter. In a rolling shutter, data is acquired line-by-line.

FIG. 4 illustrates this operation by either a single column 408 or a single row 410 being highlighted. A primary reason for utilizing a rolling shutter is a limit on the speed at which data can be read out. There can also be a limitation on the amount of data that can be read out at any one time. Some cameras use a global shutter. In a global shutter, the data for the complete detector array is captured simultaneously. The downside of a global shutter is the large amount of data coming from the sensor all at the same time, which can limit the frame rate. That is, it takes more time between frames because there is a significant amount of data per frame to be processed using a global shutter. Thus, rolling shutter operation collects data frames on a row by row or a column by column basis. There would be twenty-four column frames each with sixteen pixels to capture data from the entire array 400. Alternatively, there would be sixteen row frames each with twenty-four pixels to capture data from the entire array 400. Global shutter operation collects data frames from all pixels in the two-dimensional array. There would be one frame of data from three hundred eighty-four pixels to read out the entire array 400.

FIG. 5 illustrates a known two-dimensional detector array 500 used in a known LiDAR system. The 2D detector pixel array 500 includes three hundred eighty-four pixels 502 (small grey squares) overlapped with twenty-four transmitter emitter FOVs 504 (black outlined squares). In a system with parallax, an exact overlap of any particular transmitter 504 with sixteen receiver pixels 502, as shown, will only occur at one particular distance. That is, the FOVs 504 have this shape only for one measurement distance. The configuration shown in FIG. 5 does not employ a known flash transmitter which illuminates the full system FOV all at once. Instead, the transmitter includes a plurality of 24 laser emitters, that each generate a transmitter emitter FOV 504 wherein each individual laser can be fired independently. The optical beam emitted by each laser emitter corresponds to a 3D projection angle subtending only a portion of the total system FOV. That is, an emitter FOV subtends only one square, while the transmitter FOV is the full set of 24 squares. One example of such a transmitter is described in detail in U.S. Patent Publication No. 2017/0307736 A1, which is assigned to the present assignee. The entire contents of U.S. Patent Publication No. 2017/0307736 A1 are incorporated herein by reference.

A LIDAR system which uses multiple laser emitters as shown has many advantages, including a higher optical power density, while still maintaining eye safety limits. In order to have the fastest data acquisition rate (and frame rate), it is preferred that only the pixels 502 corresponding to a single laser (i.e. the sixteen pixels 502 in a particular emitter FOV 504) be utilized during a particular measurement sequence. Since an individual laser emitter reflects only to a specific area at a particular range, the overall system speed can be optimized by proper selection of the detector region to activate only those pixels that corresponds to a particular emitter.

A challenge with known LiDAR systems is that a projection of the transmitter emitter illumination FOV on the detector array collection area FOV strictly holds only at one measurement distance as described above. At different measurement distances, the shape of the transmitter illumination region that is reflected from a target onto the detector array is different. To make clear the distinction between the FOV projection that holds at one distance, and the more general overlap condition that holds at other distances, we refer to an image area. The image area as used herein is the shape of the illumination that falls on the detector from a range of measurement distances. The size and shape of an image area for a particular system can be determined based on the system measurement range (the range of distances over which the system takes measurements), the relative position and angle of the optical axes of the transmitter and receiver, and the size, shapes and positions of the emitters in the transmitter and the detectors in the receiver, as well as other system design parameters.

One feature of the present teaching is that method and systems according to the present teaching utilizes the known relationship between the optical axes and relative positions of a transmitter and receiver, and predetermines the image area for each emitter in a transmitter. This information can then be used to process collected measurement data, including data that is collected in regions of overlap between the image area of two different emitters. The processing can, for example, eliminate redundant data points, reduce the impact of noise and ambient light by selecting the best data point(s) in an overlap region, and/or produce multiple returns from different distances along a particular direction. The processing could also be used to improve image quality including the reduction of blooming.

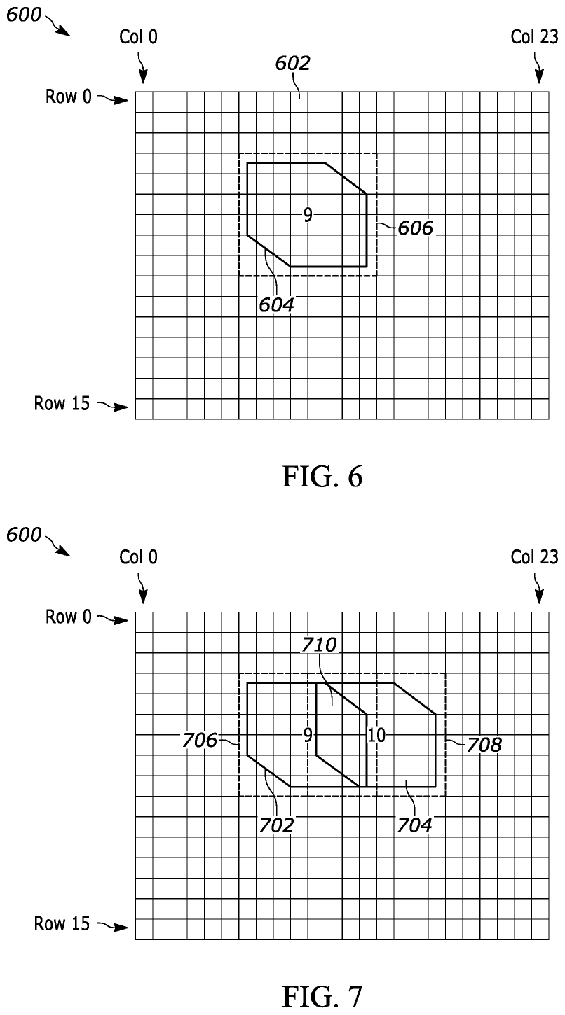

FIG. 6 illustrates the impact of parallax of a single laser in an embodiment of a two-dimensional detector array 600 used in a pixel-mapping LiDAR system of the present teaching. The array 600 includes three hundred eighty-four pixels 602. Some embodiments of LiDAR systems using detector arrays of the present teaching are illuminated by transmitters with multiple emitters, and each emitter generally does not illuminate the full field of few of the receiver array. As such, as shown in the system 500 and described in connection with FIG. 5, multiple transmitter emitter FOVs (that combine to create the full transmitter FOV) are present when projected on the receiver array FOV. The FOV projection is based at least in part on the relative positions of the transmitter optical axis and the receiver optical axis. Parallax impacts the image formed by a single laser emitter assuming that either a single target or multiple targets extend over some finite range. In this image, there is a component of parallax in both the vertical and horizontal directions. As such, referring also to FIG. 5, the rectangular FOV 506 corresponding to a single target distance for laser emitter number nine spreads diagonally into the polygon shape image area 604 labeled with a 9. This image area 604 includes reflections that occur over a range of target distances. The dashed line 606 forming a rectangle that outlines a set of pixels 602 that completely circumscribes the laser image, image area 604, indicates the receiver pixel region that would need to be selected for this particular laser emitter to ensure there is no loss of data over the range of target distances in which there is reflection from some target.

FIG. 7 illustrates the impact of parallax for two adjacent lasers in the embodiment of the two-dimensional detector array 600 of FIG. 6. Referring also to FIG. 5, the emitter nine rectangular FOV 506 and the emitter ten FOV 508 corresponding to a range of target distances both spread diagonally into the polygon shape image area 702 for emitter nine and into the polygon shape image area 704 for emitter ten. Parallax impacts the image formed by the two adjacent lasers (emitter nine and emitter ten for this example), assuming that either a single target extends over a range of distances from the transmitter or multiple targets extend over some finite range. It can be seen that the image areas 702, 704 of the two laser emitters, nine and ten, now partially overlap. In FIG. 5, which corresponded to a single measurement distance, there is no overlap between the projected laser images, FOVs 506, 508.

In FIG. 7, the regions 706, 708 for the two sets of pixels that circumscribe the pixels corresponding to the two laser emitters, nine and ten, also partially overlap. In such case, there will be a set of pixels 710 corresponding to an overlap region that corresponds to measurements for illumination that arise from two (or more) lasers. The overlap region in some embodiments is neither a full row nor a full column of pixels in the array 600. The parallax effect is particularly dramatic for LiDAR systems where the FOVs of individual emitters or emitter groups is small. For example, the parallax effect is particularly strong for systems in which only a subset of a row and/or a column of individual pixels is illuminated by an energized emitter, or simultaneously energized group of emitters that represent a single measurement. In some embodiments, a single measurement is associated with a single pulse of laser light from an energized emitter or group of emitters.

In some embodiments, at least one subset of pixel(s) used in conjunction with one laser emitter overlaps with at least one subset of pixel(s) used in conjunction with a different laser emitter. The system includes a processor (not shown) that processes the data obtained from pixels in the overlap region by analyzing and combining data obtained from this overlap region and creating a combined single point cloud based on this processed data. In some embodiments, the processor dynamically selects the illuminated pixels (i.e. pixels in an image area of two or more energized laser emitters) that are associated with a particular laser emitter based on the return pulses contained in the data generated by the illuminated pixels. Various return pulse properties can be used to dynamically select a particular laser, including, for example, return pulse strength, noise level, pulse width and/or other properties. Referring to FIG. 2B as an example, in some embodiments, the processor that processes data obtained from pixels of the array 210 can be part of the host system processor 274, controller and interface electronics 262, the receive and time-of-flight and intensity computation electronics 268, and/or a combination of any or all these processing elements 274, 262, 268.

In some embodiments of the present teaching, only a portion of the array of pixels are activated for a particular measurement (e.g. not a full row and/or not a full column). In these embodiments, a two-dimensional matrix-addressable detector array can be used. In some embodiments, the two-dimensional matrix-addressable detector array is a SPAR array. In some embodiments of the present teaching, only a portion of an array of laser emitters are energized for a particular measurement. For example, less than a full row and/or less than a full column can be energized. In these embodiments, a two-dimensional matrix-addressable laser array can be used. In some embodiments, the two-dimensional matrix-addressable laser array is a VCSEL array. In some embodiments the transmitter components are all solid-state, with no moving parts.

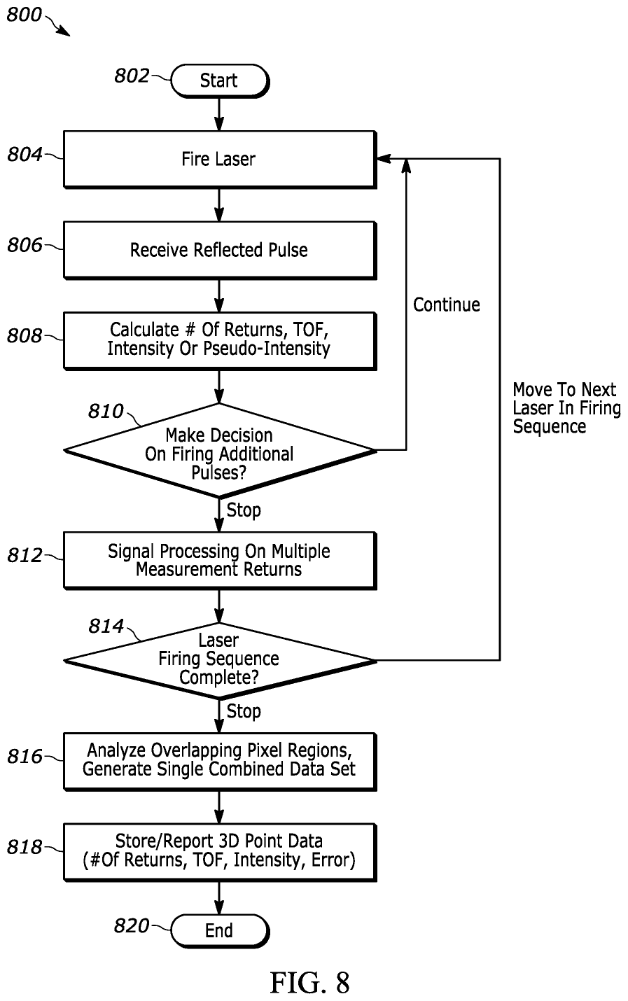

FIG. 8 illustrates a flow diagram 800 of steps in an embodiment of a method of pixel mapping for LiDAR of the present teaching. This method provides an integrated four-dimensional (4D) point cloud in a LIDAR system of the present teaching. By 4D, we mean three spatial dimensions plus intensity. In a first step 802, measurement is initiated. In a second step 804, a selected laser emitter is fired. That is, an individual laser is controlled to initiate a single measurement by generating an optical pulse. It should be understood that in various methods according to the present teaching, selected individual and/or groups of lasers are fired to generate a single pulse of light, such that a desired pattern of laser FOVs are illuminated on a given single-fire measurement cycle. In some embodiments, the transmitter laser power is varied as a function of the range to the target. In some embodiments, the transmitter pulse length is varied as a function of the range to the target.

In a third step 806, a reflected return signal is received by the LIDAR system. In a fourth step 808, the received reflected return signal is processed. In some methods, the processing of the return signal determines the number of return peaks. In some methods, the processing calculates a distance to the object based on time-of-flight (TOF). In some methods, the processing determines the intensity, or the pseudo-intensity, of the return peaks. Various combinations of these processing results can be provided. Intensity can be directly detected with p-type-intrinsic-n-type-structure detectors (PIN) or Avalanche Photodetector (APD). Also or alternatively, intensity can be detected with Silicon Photo-Multiplier (SiPM) or Single Photon Avalanche Diode Detector (SPAD) arrays that provide a pseudo-intensity based on number of pixels that are triggered simultaneously. Some embodiments of the method further determine noise levels of the return signal traces. In various embodiments of the method, additional information is also considered, for example, ambient light levels and a variety of environmental conditions and/or factors.

In a fifth step 810, a decision is made about firing the laser to generate another pulse of light from the laser. If the decision is yes, the method proceeds back to the second step 804. In various embodiments of the method, the decision can be based on, for example, a decision matrix, an algorithm programmed into the LIDAR controller, or a lookup table. A particular number of laser pulses is then generated by cycling through the loop including the second step 804, third step 806, and the fourth step 808 until the desired number of laser pulses have been generated and the decision step 810 returns a stop and proceed to the sixth step 812.

The system performs multiple measurement signal processing steps in a sixth step 812. In various embodiments of the method 800, the multiple measurement signal processing steps can include, for example, filtering, averaging, and/or histogramming. The multiple measurement signal processing results in a final resultant measurement from the processed data of the multiple-pulse measurements. These resultant measurements can include both raw signal trace information and processed information. The raw signal information can be augmented with flags or tags that indicate probabilities or confidence levels of data as well as metadata related to the processing of the sixth step.

At a seventh step 814, the system moves to a decision loop that controls the next laser in some firing sequence, and continues to loop through the full list of lasers in a firing sequence until one complete set of measurements for all the lasers in the firing sequence have been obtained. When the method progresses to the second step 804 from the seventh step 814, a new, different, laser is fired. The firing sequence determines the particular laser that is fired on a particular loop. This sequence can, for example, correspond to a full frame or a partial frame.

In another possible embodiment, the loops 810 and 814 are combined such that a sub-group of lasers is formed, where the firing of the lasers is interleaved, so as to reduce the duty cycle on any individual laser compared to firing that single laser with back-to-back pulses, but still maintain a relatively short time between pulses for a particular laser. In this alternate embodiment, the system would step through a number of sub-groups to complete either a full or partial frame.

In the eighth step 816, the system analyzes the complete data set from the firing sequence and takes various actions on the data in any overlapping pixel regions. This can be, for example, overlap region 710 described in connection with FIG. 7. The actions could include combining data in the overlapping pixel regions which has two separate TOF distances, to create multiple returns in a particular angular direction. In some embodiments, the combination of measurement data from overlapping pixels results in multiple returns for a particular angular direction. In these embodiments, the combination of measurement data from overlapping pixels results in at least some of the TOF returns being discarded, leaving only one return in the combined measurement data. In some embodiments, the system might choose to discard one set of TOF data, for example, if the distances are largely identical and one measurement is preferred based on some criteria. The criteria could be, for example, noise level, or intensity level of the return, or some other metric. In some embodiments, the system might use the overlapping data to perform image analysis to correct for image defects such as blooming.

In the ninth step 818, the combined 4D information determined by the analysis of the multi-measurement return signal processing is then reported. The reported data can include, for example, the 3D measurement point data (i.e. the three spatial dimensions), and/or various other metrics including number of return peaks, time of flight(s), return pulse(s) amplitude(s), errors and/or a variety of calibration results. In a tenth step 820, the method is terminated.

There are many ways of selecting individual and/or groups of lasers and/or detectors. See, for example, U.S. Provisional Patent Application No. 62/831,668 entitled “Solid-State LIDAR Transmitter with Laser Control”. See also U.S. Provisional Application No. 62/859,349, entitled “Eye-Safe Long-Range Solid-State LIDAR System” and U.S. patent application Ser. No. 16/366,729, entitled “Noise Adaptive Solid-State LIDAR System”. These patent applications are all assigned to the present assignee and are all incorporated herein by reference.

An important feature of some aspects of the present teaching is the recognition that parallax causes the image area of a particular laser emitter (or group of emitters) to distort if the target extends over a range of distances from the LiDAR when compared to the FOV provided at a single target range. This distortion causes some overlap between FOVs from adjacent emitters for measurements from a range of target distances. For example, this parallax can be characterized based on a position of an emitter, an angle of the optical axis of illumination from the transmitter, and/or a position of a pixel and an angle of an optical axis of illumination collected by the pixel. The optical axis of the transmitter is not coincident with the optical axis of the receiver. By performing analysis and processing of the received data and using this known parallax, it is possible to analyze the regions of overlap and process the data to account for, and use to benefit, the information contained in these regions. The result is a single, informative, combined data set that is helpful to identify objects in the three-dimensional space probed by the LiDAR.

### EQUIVALENTS

While the Applicant's teaching is described in conjunction with various embodiments, it is not intended that the Applicant's teaching be limited to such embodiments. On the contrary, the Applicant's teaching encompasses various alternatives, modifications, and equivalents, as will be appreciated by those of skill in the art, which may be made therein without departing from the spirit and scope of the teaching.

What is claimed is:

1. A Light Detection and Ranging (LiDAR) system comprising:
a) a transmitter comprising a first laser emitter that generates a first optical beam comprising a first Field-of-View (FOV) when energized and a second laser emitter that generates a second optical beam comprising a second FOV when energized, the transmitter projecting the first and second optical beams along a transmitter optical axis when energized; and
b) a receiver configured to collect light reflected from an object along a receive optical axis, the receiver comprising:
i) an array of pixels positioned with respect to the receive optical axis such that light from the first optical beam reflected from an object forms a first image area on the array of pixels and light from the second optical beam reflected by the object forms a second image area on the array of pixels such that an overlap region between the first image area and the second image area is formed based on a measurement range and based on a relative position of the transmitter optical axis and the receive optical axis; and
ii) a processor that determines what pixels are in the overlap region from electrical signals generated by at least one pixel in the overlap region and that generates a return pulse in response to the determination.

2. The LiDAR system of claim 1 wherein the overlap region is characterized by a size of the region.

3. The LiDAR system of claim 1 wherein the overlap region is characterized by a shape of the region.

4. The LiDAR system of claim 1 wherein the overlap region is characterized by a position of the array of pixels.

5. The LiDAR system of claim 1 wherein at least one of the first laser emitter and the second laser emitter comprise a VCSEL emitter.

6. The LiDAR system of claim 1 wherein the first laser emitter and the second laser emitter are formed in an array.

7. The LiDAR system of claim 6 wherein the array comprises a VCSEL array.

8. The LiDAR system of claim 1 wherein the laser array comprises a two-dimensional array.

9. The LiDAR system of claim 8 wherein the VCSEL array is a 2D matrix-addressable array such that the transmitter can illuminate a FOV which is neither a full row or a full column in width and height, respectively.

10. The LiDAR system of claim 1 wherein the transmitter further comprises a third laser emitter.

11. The LiDAR system of claim 1 wherein the transmitter further comprises transmit optics.

12. The LiDAR system of claim 1 wherein the transmitter is configured such that the first laser emitter generates the first optical beam comprising a pulsed optical beam.

13. The LiDAR system of claim 12 wherein an intensity of at least one of the laser pulses varies based on a range to the object.

14. The LiDAR system of claim 12 wherein a pulse width of at least one of the laser pulses varies based on a range to the object.

15. The LiDAR system of claim 1 wherein the receiver further comprises receive optics.

16. The LiDAR system of claim 1 wherein the array of pixels comprises a two-dimensional array.

17. The LiDAR system of claim 1 wherein the array of pixels comprises a detector array.

18. The LiDAR system of claim 1 wherein the array of pixels comprises a SPAD array.

19. The LiDAR system of claim 1 wherein the array of pixels is configured such that only a subset of pixels is activated for a particular measurement.

20. The LiDAR system of claim 1 wherein at least one pixel in the overlap region is configured to receive multiple returns from a particular angular direction.

21. The LiDAR system of claim 1 wherein the processor is configured to discard at least one time-of-flight return from at least one pixel in the overlap region.

22. The LiDAR system of claim 1 wherein the processor is configured to perform image analysis on the overlap region.

23. A method of Light Detection and Ranging (LiDAR), the method comprising:
a) generating a first optical beam comprising a first Field-of-View (FOV);
b) generating a second optical beam comprising a second FOV;
c) projecting the first and second optical beams along a transmitter optical axis;
d) collecting light reflected from an object along a receive optical axis with an array of pixels positioned with respect to the receive optical axis such that light from the first optical beam reflected from an object forms a first image area on the array of pixels and light from the second optical beam reflected by the object forms a second image area on the array of pixels such that an overlap region between the first image area and the second image area is formed based on a measurement range and based on a relative position of the transmitter optical axis and the receive optical axis;
e) determining what pixels are in the overlap region from electrical signals generated by at least one pixel in the overlap region; and
f) generating a return pulse in response to the determination.

24. A method of pixel mapping for Light Detection and Ranging (LiDAR) to provide an integrated four-dimensional (4D) point cloud, the method comprising.
a) selecting laser(s) to generate a single pulse of light, such that a desired pattern of laser FOVs are illuminated;
b) receiving a reflected return signal from a target;
c) processing the reflected return signal;
d) firing selecting laser(s) to generate other single pulses of light such that a desired pattern of laser FOVs are illuminated based the processing and on predetermined decision criteria; and
e) analyzing data from the firing of the selected lasers to determine four-dimensional (4D) point cloud information.

25. The method of claim 24 wherein the processing the reflected return signal comprises determining a number of return peaks.

26. The method of claim 24 wherein the processing the reflected return signal comprises calculating a distance to the object based on time-of-flight.

27. The method of claim 24 wherein the processing the reflected return signal comprises determining noise levels of the return signal traces.

28. The method of claim 24 wherein the processing the reflected return signal comprises determining an intensity or a pseudo-intensity of the return peaks.

29. The method of claim 24 further comprising varying a power of the selected laser(s) that generates the single pulse of light as a function of the range of the target.

30. The method of claim 24 further comprising varying a pulse length of the selected laser(s) that generates the single pulse of light as a function of the range of the target.
